(19) United States
(12) Patent Application Publication
(10) Pub. No.: US 2023/0028681 A1
(43) Pub. Date: Jan. 26, 2023

(54) SYSTEM AND METHOD FOR BLOCKCHAIN-BASED EMPLOYMENT VERIFICATION

(71) Applicant: DISH Wireless L.L.C., Englewood, CO (US)

(72) Inventors: Katie Flynn, Englewood, CO (US); Phap Lam, Colfax, IA (US)

(21) Appl. No.: 17/384,216

(22) Filed: Jul. 23, 2021

(51) Int. Cl. G06Q 30/00; G06Q 10/10; G06F 16/27; H04L 29/06

(52) U.S. Cl. CPC G06Q 30/018; G06F 16/27; G06Q 10/1053; H04L 63/102

(57) ABSTRACT

Techniques are described for receiving an online request to verify an asset, e.g., a line-item from an online profile. The technique determines a verifying entity, such as an educational institution, that has authority to verify the line-item, e.g., an earned certificate, and sends a request to such verifying entity to do so. The asset is added to and verified on the distributed ledger or is verified before adding to the distributed ledger. A verification indicator is coupled to the asset, signaling that the asset has been verified once and need not be verified again. A notification that the asset is verified is transmitted to interested parties. The verification may be at a level, such as a one day verification of a negative drug test. The verifications are searchable on the distributed ledger, e.g., an employer may query for verified assets that match job-related requirements.

### BACKGROUND

Presently, companies and other institutions spend many resources, including time, to perform employment checks on candidates, prospective hires. Such employment checks may include background checks, such as drug screening and employment validation. As well, individuals at these companies conduct many interviews, for example, technical interviews for software and hardware developers, coding interviews to verify coding language and technique competencies and proficiencies. Further, companies may be required to perform many additional steps on the internet, such as generating many emails and performing many search queries. Further, companies may take actions online, such as create customized or proprietary online testing or verification tools. Also, companies perform checks, such as contacting candidate references and review or verify educational transcripts. Companies also accept special career certifications (for example, but not limited to, project management certification (e.g., Project Management Professional (PMP®) and Amazon Web Services (AWS), etc.).

The patent or application file contains at least one drawing executed in color. Copies of this patent or patent application publication with color drawing(s) will be provided by the Office upon request and payment of the necessary fee.

### BRIEF DESCRIPTION OF THE DRAWINGS

FIG. 1 is a schematic diagram of a high-level architecture of the network environment, according to an embodiment.

FIG. 2 is a flow diagram showing a method for verifying a user’s asset in an online document for the purpose of employment, according to an embodiment.

FIG. 3 is a flow diagram showing another method for verifying a user’s asset in an online document for the purpose of employment, according to an embodiment.

FIG. 4 is a block diagram of a processing system that can implement operations of the disclosed embodiments.

### DETAILED DESCRIPTION

Techniques are described for receiving an online request to verify an asset, e.g., a line-item from an online profile. The technique determines a verifying entity, such as an educational institution, that has authority to verify the line-item, e.g., an earned certificate, and sends a request to such verifying entity to do so. The asset is added to and verified on the blockchain or is verified before adding to the blockchain. A verification indicator is coupled to the asset, signaling that the asset has been verified once and need not be verified again. A notification that the asset is verified is transmitted to interested parties. The verification may be at a level, such as a one day verification of a negative drug test. The verifications are searchable on the blockchain, e.g., an employer may query for verified assets that match job-related requirements.

As mentioned above, presently, companies spend many resources, including time, to perform employment checks on candidates, prospective hires. Such employment checks may include background checks, such as drug screening and employment validation. As well, individuals at these companies conduct many interviews, for example, technical interviews for software and hardware developers, coding interviews to verify coding language and technique competencies and proficiencies. Further, companies may be required to perform many additional steps on the internet, such as generating many emails and performing many search queries. Further, companies may take actions online, such as create customized or proprietary online testing or verification tools.

When hundreds of thousands or millions of employers and job candidates across the globe are in the process of seeking employees and seeking employment, respectively, a lot of cost is had. Not only is the employment process time-consuming and arguably archaic, a lot of processing cost is had, a lot of server charges are made, and a lot of data is going back and forth, across the Internet. These processing events directly affect the performance of the users involved in the process and the performance of the internet, in general. The Internet slows down. Their respective servers slow down.

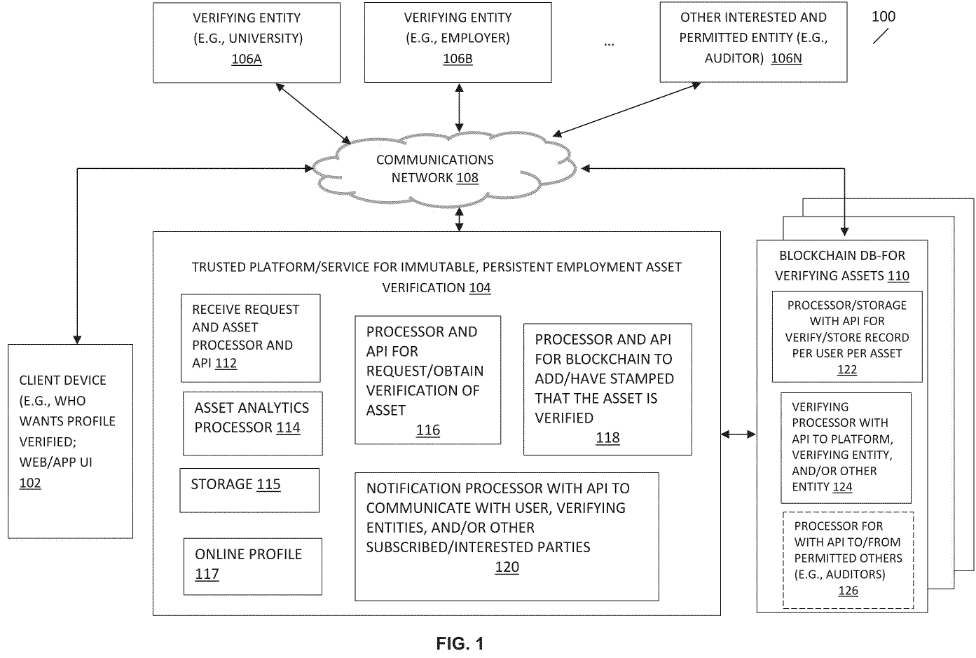

One or more embodiments can be understood with reference to FIG. 1, a schematic diagram of a high-level architecture of the network environment. A user who has an online profile, online resume, or some other document or part of document, sends a request, from a client device 102, to a platform 104 for verifying the document or a part of the document. The content for which verification is requested is referred to herein as an asset. The platform 104 is configured to receive the request for verification and the asset, which may be embedded in a document, by processor and API112. The client device 102 transmits and receives communication to and from the platform 104 over a communications network 108. The input is processed by asset analytics processor 114. For example, asset analytics processor 114 parses the input, if required, and determines therefrom the asset, if required, and a verifying entity associated with the asset, where the verifying entity has the authority to verify the asset. The processor and API for request/obtain verification of asset 116 subsequently transmits a request over the communications network 108 to the identified verifying entity (106A or 106B) to verify the asset. It should be appreciated that while 106A (e.g., a university) or 106B (e.g., an employer) are shown, one skilled in the art would understand that these are by way of example and that other or more verifying entities are contemplated. For example, another verifying entity is a course instructor capable of issuing course certificates of completion. Simultaneously, before, or after transmitting the request to the verifying entity to verify the asset, processor and API for blockchain 118 digitally signs and adds a first transaction to blockchain database 110, where the signed transaction includes content representing the asset, as well as the digital signature. Processor and storage with API 122 is configured to verify and store the transactions or records per user per asset. For instance, the platform 104 digitally signs the asset and adds the asset with the signature to processor and storage 122. Further, the blockchain database 110 is configured to be accessed by the verifying entity (106A or 106B) for verifying the asset. Processor and API for request/obtain verification of asset 116 transmits a notification to verifying entity (106A or 106B) that a blockchain transaction for verifying an asset is available on the blockchain (110, 122). In response, the verifying entity (106A or 106B) accesses the transaction on the blockchain (110, 122), verifies the asset, and signs the transaction, e.g., by adding a second transaction, to indicate that the asset has been verified (110, 122, 124). In response to the asset being verifies, the blockchain 110 is configured to send a notification (110, 124) that the asset has been verified by the associated verifying entity (106A or 106B) to the platform (110, 118). The platform (110, 120) notifies the client device 102 that the asset has been verified. It should be appreciated that in another embodiment, after having verified the asset, the verifying entity (106A or 106B) informs either the platform 116 or the client device 102 of such verification. In another embodiment, the blockchain (110, 126) is configured to notify the client device 102 that the asset has been verified.

As an example use case, the user pays for the verification service to the platform and the platform reaches out to the educational institution (e.g., Harvard) and essentially asks if the person went school there and achieve particular results that he’s represented on his profile. Then, if so, the educational institution stamps on the blockchain. The platform ensures that the stamps (or other indicator) is imprinted or associated with the profile.

In an alternative embodiment, instead of the asset being verified by the associated verifier, the platform 110 itself is configured to contact the verifying entity (106A or 106B) to obtain information that the asset is verified, and signing and adding a transaction to a blockchain database, wherein the signed transaction indicates that the asset has been verified, wherein the transaction includes content representing the asset and an indicator of verification by the verifying entity.

In an embodiment, the innovation can be implemented by an existing company as a third part authenticator, where the existing company has a large, robust infrastructure that already processes and stores online job profiles. For example, such existing could form a partnership with particular educational institutions and provide a platform to which such institutions can go in and verify people’s education. For example a nominal fee (e.g., $10) can be paid to the online job profile platform for the service of verifying an item or asset on one’s online profile.

In an embodiment, the platform 104 is configured to host a website application on the cloud. Client device 102 communicates via communications network 108 with such website application.

In an embodiment, an asset is associated with a particular individual and is digital information representing one of: a line of a resume; a degree from a secondary education institution; a certificate of qualification for being able to draft executable code in a specific coding language; a professional reference; one or more specific courses completed at an educational institution; job history; length of time employed at a specific place of employment; employment dates; length of time in a specific position at a specific place of employment; performance at those jobs; books or papers written; a transcript from an educational institute; a resume; a profile; a document; electronic records associated with the user; and a result of drug screening or a drug test.

In an embodiment, the client device 102 is the device from which a user can request to verify parts of their online profile. For example, from client device 102, the user can request the platform 104 to verify that they earned a specific certificate in a specific programming language. Or, similarly, the user can request that their college degrees listed on their online profile are verified once and for all, i.e., permanently. The client device 102 is a computing device such as a laptop, tablet, desktop personal computer, and smartphone, each of which can support a client application. The client device 102 can be a device that supports a web browser that connects to a server, such as platform 104.

In an embodiment, the communications network 108 is illustrated as a generic communication system. In one embodiment, the communication network 108 comprises the internet. In one embodiment, the communication network 108 may perform other auxiliary operations, such as authentication, rate limiting, and so on. Accordingly, interfaces may be a modem or other type of internet communication device. Alternatively, the communication network 108 may be a telephony system, a radio frequency (RF) wireless system, a microwave communication system, a fiber optics system, an intranet system, a local access network (LAN) system, an Ethernet system, a cable system, a radio frequency system, a cellular system, an infrared system, a satellite system, or a hybrid system comprised of multiple types of communication media. In such embodiments, interfaces are configured to establish a communication link or the like with the communication network 108 on an as-needed basis, and are configured to communicate over the particular type of communication network 108 to which it is coupled.

In an embodiment, the platform 104 is configured with processors with APIs and a storage to perform processing operations and to communicate with the client device 102, verifying entities (106A or 106B), other entities (106N) and the blockchain database component (110). Platform 104 hosts a receive request and asset processor and API 112; an asset analytics processor 114; a storage 115; an online profile processor with API and repository 117; a processor and API for request/obtain verification of asset 116; a processor and API for blockchain to add/have stamped that the asset is verified 118; and a notification processor with API to communicate with user, verifying entities, and/or other subscribed/interested parties 120, each of which are described in more detail below.

In an embodiment, platform 104 is considered a third-party authenticator, a separate intermediary (e.g., between the user and the verifying entity). Each of the parties (e.g., user and verifying entity) are registered users to the platform.

In an embodiment, the receive request and asset processor and API 112 is configured to receive data in the form of a document. For instance, the user at client device 102 inputs or transmits an entire online resume. In another embodiment, the receive request and asset processor and API 112 is configured to receive data in the form of structured data, such as data from input fields completed by the user from the client device 102. As an example, the receive request and asset processor and API 112 presents UI to the user requesting specific information such as certificate bestowed or degree earned and the name of the institution that granted such certificate or degree. For example, the user can enter “bachelor’s of arts in mathematics” and “University of California.”

In an embodiment, online user profiles 117 stores digital information such as user names, sign on credentials, history of past activities, other administrative related tasks, user profile information, and online job profile related information. In an example, the platform 104 is configured such that the online user profile 117 component maintains a list of the user’s assets that had been verified by the platform. The list can include metadata of each asset, such as for example, whether the verification is permanent or temporary. Thus, a user can access their online profile and ascertain which assets are verified and which may need verification. In an embodiment, the platform 104 can use an online profile from component 117, parse and/or reformat parts of it, and use such reformatted part as input to the blockchain for verification by a verifying entity.

In an embodiment, the online job profile (e.g., a Linkedln type of profile or a resume) is configured such that at least one line item on it is verifiable on the blockchain. The online job profile can be considered a digital representation of the user. Such online job profile is configured to includes items such as references, where the user went to school, and items similar to those on a current resume document.

Thus, with such innovative online job profile, in which items thereon are immutably verified, a company or entity in a similar position can focus its efforts on a cultural interview, to make sure that the job candidate has a personality or other targeted characteristic fit. Presently, companies perform many more operations than that. Thus, the innovation streamlines the whole hiring and employment process, especially when, as consistent with embodiments herein, the job candidate has a profile that is stamped or otherwise indicated that certain line item assertions (e.g., graduated from a particular college with a particular degree or earned a certificate of completion of a particular coding course) are validated and certified true. It is contemplated that, with this innovative platform and online job profile, a company can narrow their job hiring process for each individual to a shorter, e.g., thirty minute, interview to determine whether the candidate is a good fit for the company.

In an embodiment, the user transmits the asset to the platform 104 for verification by executing a mobile device application or an application or portal on a website. In another embodiment, the platform is configured to receive the asset as user input by transitory or nontransitory storage, such as on an external hard drive.

It should be appreciated that other required input, such as dates degrees or certificates are conferred, are contemplated and within scope of the innovation.

Storage 115 represents persistent or temporary storage, depending on the embodiment or use. Storage 115 has storage capabilities, such as but not limited to dictionaries, look-up tables, database, and related support. For instance, storage 115 is configured to store persistent data associated with user profiles, such as the list of verified assets, time history of when assets were verified, and statuses of verifications that are temporal.

In an embodiment, asset analytics processor 114 is configured to take a digital input, such as a digital document or part thereof, and parse such input to extract the asset. The innovation includes a predetermined set of rules for parsing the document, such as using word recognition techniques and matching extracted words or phrases and matching them against a predetermined list of similar terms or phrases. For instance, the rules may extract “Harvard,” match “Harvard” against a list that contains “Harvard” and from there make the determination that the associated verifying entity is Harvard University. Similarly, in another example, the term or phrase “Professional Certificate in blah-blah-blah” is extracted, compared to a items in a predetermined list, and a determination is made that a particular institution is the associated verifying entity.

In another embodiment, the digital input is a digital resume or digital profile and the asset is an item on the resume. The asset analytics processor 114 is configured to parse such input and output one or more line-items or document objects that are verifiable. The asset analytics processor 114 is configured to follow particular rules that inform such processor what types of words or phrases for which to search, or, alternatively, at which locations of the document to search.

In another embodiment, the asset analytics processor 114 is configured to accept input according to specific rules and output the verifying entity clearly. In an example, the asset analytics processor 114 receives as input two objects: the type or name of the certificate or degree and the institution that issues such certificate (e.g., bachelor’s in science and Harvard). The asset analytics processor 114 subsequently matches such input with a predetermined list and outputs that the verifying entity is Harvard University.

In an embodiment, asset analytics processor 114 is configured to determine a level of verification of the asset based on the type of asset and a set of a predetermined hierarchy of levels. The hierarchy of levels reflects temporal levels and each temporal level reflects a particular degree and/or time duration of applicability. For example, a user’s drug screening, as an asset, might not be valid after a number of hours or days. As another example, some background screening, as assets, might be valid for a specific number of years (e.g., two years). Thus, the platform 104 is configured to handle temporal parts to each of these validations.

In an embodiment, asset analytics processor 114 is configured to determine a rank for some of the soft skills that have more of a temporary validation.

In an embodiment, if there are multiple forms of validation, e.g., a certain grade, a permanent validation, or a temporary validation, the platform is configured to generate and provide a different classification for each of the different forms of validation. For example, such forms can be color coded (e.g., a black stamp or seal could mean permanently valid or a red seal or stamp could mean that the validation is temporary). It is contemplated that in an embodiment, the majority of validations are permanent, such as for example, standard items: job history; high level performance in those jobs; one’s education, and other hard skills at the job (e.g., in technical recruiting, “Can you actually code in the languages and then the platforms that you said?”). The platform allows validating such skills and accomplishments, such that the hiring process is streamlined and faster.

In an embodiment, the platform is configured to determine a level of verification of the asset based on the type of asset and a set of a predetermined hierarchy of levels. The hierarchy of levels reflects temporal levels and each temporal level reflects a particular degree and time duration of applicability.

In an embodiment, a processor and API for request/obtain verification of asset 116 is configured to facilitate communication between platform 104 and verifying entity (106A or 106B) and/or other interested and permitted entities 106N. For example, processor and API 116 receives the request for verification from processor and API 112, configures such request so that it is suitable for the verifying entity (106A or 106B) and transmits such request to such verifying entity (106A or 106B). Conversely, processor and API 112 is configured to receive communication from verifying entity (106A or 106B) and transmit such communication for delivery to client device 102 (e.g., if more information is required) or to blockchain 110 via processor and API 118.

In an embodiment, processor and API for blockchain to add/have stamped that the asset is verified 118 is configured to communicate from/to platform 104 to/from blockchain 110, e.g., via processor and API 124 on blockchain 110. For example, processor and API 118 can transmit requests to the blockchain 110, the requests intended for the blockchain to perform the processing for obtaining the verification stamp or indicator from the verifying entity (106A or 106B). The processor and API 118 adds a signed transaction that contains the content of the asset to be verified. The processor and API 118 makes the verification request to the verifying entity and obtains the new transaction that contains digitally signed content that represents that the asset is verified. In another implementation, processor and API 118 can make the request to the verifying entity to verify the asset, e.g., via 116. Upon obtaining information from the verifying entity that the asset has been verified, processor and API 118 can itself add a transaction to the blockchain 110, the transaction containing the asset, an indicator (e.g., timestamp) that the asset has been verified, and a digital signature by processor and API 118.

In an embodiment, processor with API 120 is configured to communicate with the user, the verifying entities, and/or other subscribed/interested parties for the purposes of transmitting notification-type communications. For instance, processor with API 120 is configured to receive a signal originating from blockchain 110 that the verifying entity has verified the asset on the blockchain 110. Processor with API 120 is configured to subsequently and in response thereto send a notification to the user at client device 102 that the asset has been verified. Similarly, processor with API 120 is configured to send a notification to verifying entity (106A or 106B) that the asset has been properly verified or that the transaction is complete. In an embodiment, processor with API 120 is configured to receive a signal originating from blockchain 110 that the other interested and permitted entity 106N will audit, is in the process of auditing, or has audited the asset on the blockchain 110. Processor with API 120 is configured to send a notification to client device 102 that the asset will be audited, is in the process of being audited, or the auditing of the asset on the blockchain 110 is complete. In an embodiment, the notification indicates a type of completion score or a type of designation that what has been requested to be validated was indeed validated. The completion score could indicate that only some of the items were validation. In another implementation, the indicators or markers could convey a level that is associated with the asset. For instance, the marker could be a glowing gold if the validation was from Harvard, MIT, or other prestigious institution.

In an embodiment, the verifying entity (106A or 106B) is a computing device, such as a desktop computer, laptop, and tablet, for example, configured to communicate via communications network 108 with platform 104, e.g., via processor and API 116. The verifying entity (106A or 106B) is further configured to communicate via communications network 108 with the blockchain 110, e.g., via 124. The verifying entity can be an entity acting on behalf of a university, an employer, a course instructor, for example.

In an embodiment, the platform 104 is configured to negotiate trust with an interested entity 106N, to give permission to access, query, and retrieve from the blockchain 110, information about whether a particular asset is verified. The interested entity 106N communicates with the blockchain 110 via communications network 108 and can obtain the queried verification information therefrom. In another embodiment, interested entity 110 communicates via communication network 108 with the platform (110, 116) and obtains therefrom information about the verification of the particular asset. The interested entity 110 can be an auditor, acting on behalf of some agency, for example, to check the accuracy of the verification. As an example, the auditing entity device 106N works on behalf of a potential employer and matches the asset (accessed transaction on the blockchain) to an item on a candidate’s online resume for validating the item. As another example, a particular line on a resume is associated with a unique identifier so that the interested entity 106N can check on the blockchain to determine if the particular assertion of the line (e.g., that the person obtained a certificate for a specific coding language) is true, instead of having all the checks associated with the resume performed.

In an embodiment, blockchain database for verifying assets 110 is an example of the technology that supports a distributed ledger in such a way that allows the recipients of the distributed ledger to make changes to the assets within the ledger, without being able to modify any actions made on the assets in the past. Other forms of distributed ledger technology can be used within the innovation. That is, the technology ensures that each action on an asset is immutable in time -- hence, the distributed ledger. The distributed ledger keeps track of the changes made to each asset. Thus, blockchain 110 is configured to store an asset and the information indicating that the asset has been verified. Such verification is immutable using blockchain technology. Further, using blockchain technology, the blockchain 110 is configured to be queried and provide the informational data that the asset has been verified. In an embodiment, the asset along with an indication of verification is retrieved or just the verification is retrieved. Significantly, due to the immutability of blockchain technology, or another future technology that ensures immutability, the asset need be verified once. Hence, the squandering of many resources (e.g., time, power, and available bandwidth) is avoided by the platform, ensuring that an asset need be verified but once.

In an embodiment, blockchain 110 is a blockchain database coupled to the platform. In another embodiment, blockchain 110 is a distributed blockchain with two or more nodes, which are communicated with over the communications network 108. Blockchain 110 adds a layer of security, a layer of immutability. That is, once the profile or asset is stamped, it is done. The stamped profile lasts, even if the blockchain is moved off (downloaded) of the servicing platform. What has been verified remains a verified asset. The innovation provides an immutable persistent authentication for that object, the asset, via the blockchain certification aspect. Currently, there is no notion of another party certifying what one asserts to be true in the industry; institutions only certifying what is true on their own systems or platform or paper.

In an embodiment, changes are made to assets in blockchain 110 as new transactions. For example, while not very likely, it is possible that a user realized that he had entered a wrong graduation year on his resume and that such graduation year nevertheless was verified. The platform is configured so that the user can make a new request for verification of the modified asset.

In an embodiment, blockchain database 110 is a database that includes a processor and storage with API 122 for facilitating the verifying process and storing adding the transactions to the distributed ledger or immutable storage. For example, processor and storage with API 122 is configured to receive the asset or content of the asset along with or obtain the appropriate digital signatures for entry in the distributed ledger. Examples of a transaction can be a new asset or its content with a digital signature; a digital signature with content that indicates what preceded it is verified;

In an embodiment, blockchain database 110 is a database that includes a verifying processor with API to platform, verifying entity, and/or other entity 124. Processor with API 124 is configured to communicate, either directly or via communications network 108, with the platform 104. Specifically, processor with API 124 communicates with processor and API for blockchain to add/have stamped that the asset is verified 118 and with verifying entity (106A or 106B).

In an embodiment, blockchain database 110 is a database that includes a processor for with API to/from permitted others 126. This processor with API is configured to communicate over the communications network 108 to entities that are not the client or user and not the verifying entity. In an example, such entity is an auditor that is auditing verified assets on behalf on some third party. Process with API 126 is configured to communicate via email and is configured with the appropriate interface to the auditor device such that the auditor device can enter requests or queries for verified assets and receive responses about same.

In an embodiment, each of the verifying entity (106A-106B), the other interested permitted entity (106N), the trusted platform (e.g., 116), and the client and or client device (102) have identities and credentials. Various identity technologies can be employed, such as for example zero knowledge proof. Consistent with embodiments herein, each of the client or client device (102), the trusted platform (e.g., processor and API for request/obtain verification of asset 116), an the verifying entities (e.g., 106A, 106B, or 106N) uses identity in their respective processes. An embodiment uses a profile zero knowledge proof related to the user. In an embodiment, similar uses of zero knowledge proof for the other parties are employed.

In an embodiment, the innovation can be used in the aid of a job search, from either of the job candidate’s or the employer’s perspective. For example, if the other interested and permitted entity 106N is an employer, the platform 104 can be configured to notify the employer that certain job candidates meet its criteria. For instance, in an implementation, the employer 106N can be registered with a job search service offer by the platform 104. The platform 104 can be configured to receive and ingest a list of desired criteria from the employer106N. For example, the list might include a graduate of a particular degree and/or certificates in a particular programming language and a lower threshold of a number of years of employment with average or above job performance ratings. The list can include required authenticated or verified minimums. The platform can be configured to store such list of criteria in storage 115, for example. The platform 104 can be configured further to search the blockchain 110 or be notified by the blockchain of stored assets and their associated identities that match some or all of the criteria. The platform 104 can be further configured to determine that a threshold has been met (e.g., 2 of the 3 criteria are met) and send a notification to the employer 106N with a list of such associated identities (potential job candidates). In an embodiment, the platform 104 is configured to allow the job candidate 102 and the employer 104 to opt-in to this service. Then, upon a match or having met the job search criteria, the job candidate’s online job profile can be sent by the platform 102 to the employer. Similarly, the job candidate 102 can inform the platform 104 that it is seeking a job and to use its associated online profile, that has at least one verified asset, to find matching employers seeking to hire. Thus, the innovative platform 104 makes job searching easier for the users and less network intensive, as there is less searching over the Internet required, more efficient data processing, less time to retrieve data from storage, and less memory use.

In an example implementation, after the user 102 has an asset verified by the platform 104, the platform 104 can process and inform the user of a list of jobs that the user is looking for and can notify potential employers 106N that specific criteria, e.g., these exact three certificates, have found (added as a transaction to the blockchain database).

In an embodiment, the blockchain 110 is configured to be used off-platform by requiring standardized manipulation of and standardized encapsulation of the information. Such embodiment requires a profile to be certified (e.g., have verified assets consistent with embodiments herein) in the first place and then such profiles and information therein can be moved off the platform via a standardized way and encapsulation for that information. Such innovation ensures the immutability of the information and that no one can doctor or otherwise alter the information after. That is, such information is coded into the blockchain and that becomes a testable statement.

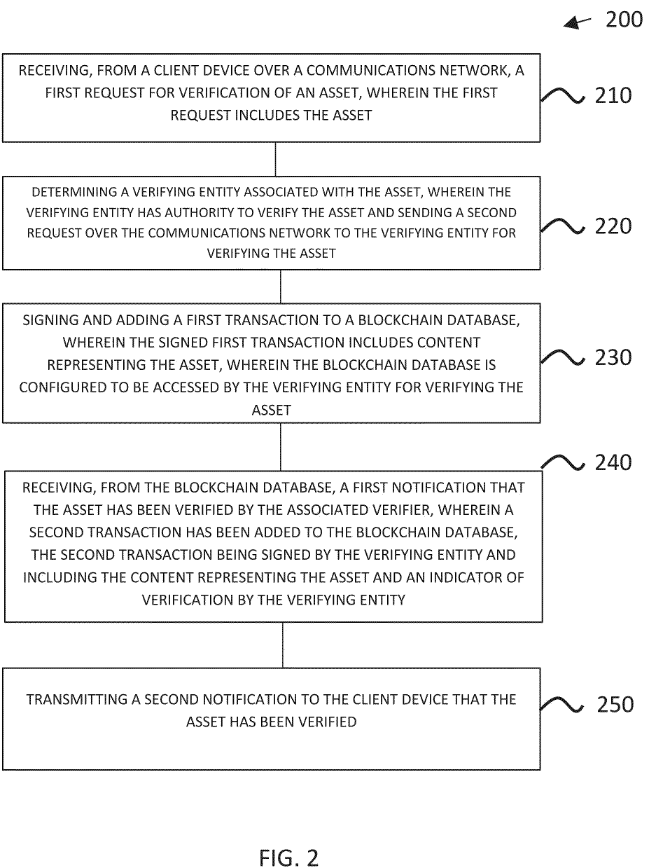

An embodiment can be understood with reference to FIG. 2, a flow diagram 200 showing a method for verifying a user’s asset in an online document for the purpose of employment. At step 210, a first request for verification of an asset (for example but not limited to, an online resume, online profile, or online line-item from a resume or profile) is received at the platform (e.g., 104) from a client device (e.g., 102) over a communications network (e.g., 108). The first request includes the asset.

At step 220, the platform determines (e.g., 114) a verifying entity (e.g., 106A, 106B) associated with the asset, where the verifying entity has authority to verify the asset and sends (e.g., 116) a second request over the communications network to the verifying entity for verifying the asset.

At step 230, the platform signs and adds a first transaction to a blockchain database (e.g., 110, 122, 124), wherein the signed first transaction includes content representing the asset, wherein the blockchain database is configured to be accessed by the verifying entity for verifying the asset.

At step 240, the platform receives (e.g., at 118) from the blockchain database a first notification that the asset has been verified by the associated verifier, wherein a second transaction has been added to the blockchain database, the second transaction being signed by the verifying entity (e.g., 110, 122, 124) and including the content representing the asset and an indicator of verification by the verifying entity.

At step 250, the platform transmits (e.g., 120) a second notification to the client device that the asset has been verified.

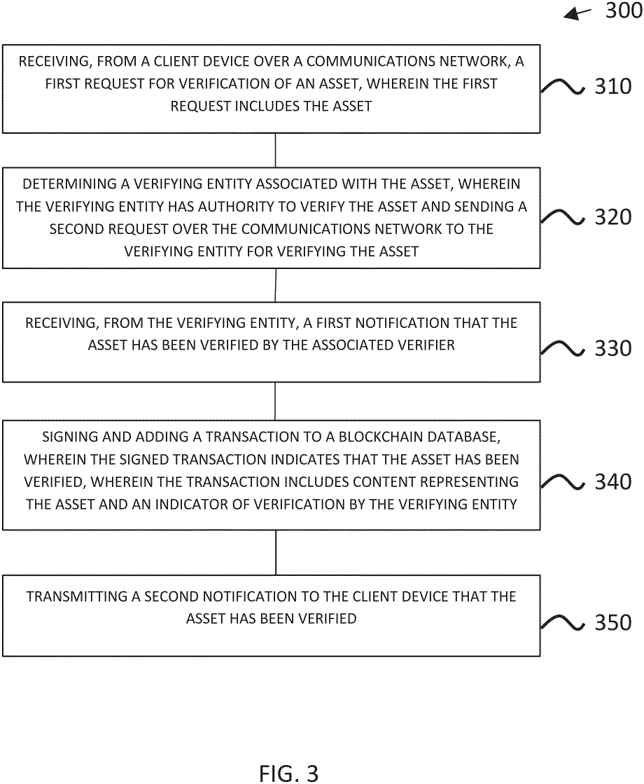

An embodiment can be understood with reference to FIG. 3, a flow diagram 300 showing a method for verifying a user’s asset in an online document for the purpose of employment. At step 310, the platform (e.g., 104) receives (e.g., 112), from a client device (e.g., 102) over a communications network (e.g., 108), a first request for verification of an asset (for example but not limited to, an online resume, online profile, or online line-item from a resume or profile), where the first request includes the asset.

At step 320, the platform determines (e.g., 114) a verifying entity (e.g., 106A, 106B) associated with the asset, where the verifying entity has authority to verify the asset and sends (e.g., 116) a second request over the communications network to the verifying entity for verifying the asset.

At step 330, the platform receives (e.g., 116), from the verifying entity, a first notification that the asset is valid, that is, has been verified by the associated verifying entity.

At step 340, the platform signs (e.g., 118) and adds (e.g., 118) a transaction to a blockchain database (e.g., 110, 122), where the signed transaction indicates that the asset has been verified and where the transaction includes content representing the asset and an indicator of verification by the verifying entity.

At step 350, the platform transmits (e.g., 120) a second notification to the client device that the asset has been verified.

### An Example Machine Overview

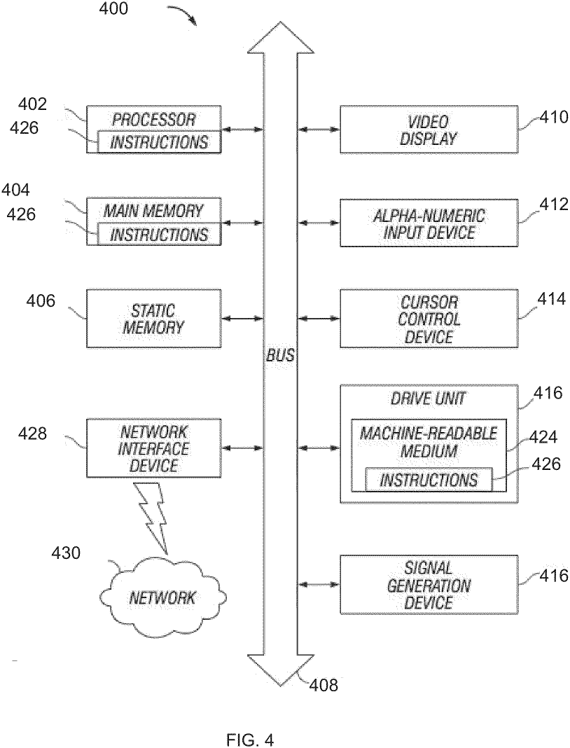

FIG. 4 is a block schematic diagram of a system in the exemplary form of a computer system 400 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 400 includes a processor 402, a main memory 404 and a static memory 406, which communicate with each other via a bus 408. The computer system 400 may further include a display unit 410, for example, a liquid crystal display (LCD) or a cathode ray tube (CRT). The computer system 400 also includes an alphanumeric input device 412, for example, a keyboard; a cursor control device 414, for example, a mouse; a disk drive unit 416, a signal generation device 418, for example, a speaker, and a network interface device 428.

The disk drive unit 416 includes a machine-readable medium 424 on which is stored a set of executable instructions, i.e. software, 426 embodying any one, or all, of the methodologies described herein below. The software 426 is also shown to reside, completely or at least partially, within the main memory 404 and/or within the processor 402. The software 426 may further be transmitted or received over a network 430 by means of a network interface device 428.

In contrast to the system 400 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users, e.g. users on the go, to purchase a product within the video on such internet-enabled or other network-enabled devices, servers, or clients. It further should be appreciated that one or more cloud computing embodiments include purchasing within the video using mobile devices, tablets, and the like, as such devices are becoming standard consumer devices.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Although the invention is described herein in terms of several embodiments, one skilled in the art will readily appreciate that other applications may be substituted for those set forth herein without departing from the spirit and scope of the present invention. Accordingly, the invention should only be limited by the Claims included below.

We claim:

1. A method, comprising:
receiving, from a client device over a communications network, a first request for verification of an asset, wherein the first request includes the asset;
responsive to receiving the first request from the client device, determining a verifying entity associated with the asset, wherein the verifying entity has authority to verify the asset and sending a second request over the communications network to the verifying entity for verifying the asset;
signing and adding a first transaction to a distributed ledger database, wherein the signed first transaction includes content representing the asset, wherein the distributed ledger database is configured to be accessed by the verifying entity for verifying the asset;
receiving, from the distributed ledger database, a first notification that the asset has been verified by the associated verifier, wherein a second transaction has been added to the distributed ledger database, the second transaction being signed by the verifying entity and including the content representing the asset and an indicator of verification by the verifying entity; and
transmitting a second notification to the client device that the asset has been verified.

2. The method of claim 1, wherein an asset is associated with an individual and is digital information representing one of: a line of a resume; a degree from a secondary education institution; a certificate of qualification for being able to draft executable code in a specific coding language; a professional reference; one or more specific courses completed at an educational institution; length of time employed at a specific place of employment; length of time in a specific position at a specific place of employment; a transcript from an educational institute; a resume; or a profile.

3. The method of claim 1, further comprising:
creating a trusted relationship with the client device by registering the client device and negotiating trust with the client device and creating a trusted relationship with the verifying entity by registering the verifying entity and negotiating trust with the verifying entity.

4. The method of claim 1, wherein the received asset is contained in a received document and further comprising parsing the received document to extract the asset.

5. The method of claim 4, wherein the received document is a digital resume or digital profile and the asset is an item on the resume.

6. The method of claim 1, wherein the indicator of verification is a time stamp of entry of the transaction into the distributed ledger database or is a predetermined mark that indicates what is associated with the mark has been verified.

7. The method of claim 1, wherein the second notification comprises the asset or a copy of the asset and comprises the indicator of verification.

8. The method of claim 1, wherein the distributed ledger database is configured to allow the added transaction to be auditable and further comprising:
negotiating trust with an auditing entity device, permitting the auditing entity to access the added transaction for validation against another item.

9. The method of claim 8, wherein the auditing entity device is of a potential employer and further comprising matching the accessed transaction to an item on a candidate’s online resume for validating the item.

10. The method of claim 1, further comprising transmitting the second notification to the verifying entity or a different interested party.

11. The method of claim 1, further comprising:
registering an interested party and negotiating trust;
granting the interested party permission to query the distributed ledger database for verified assets that match a predetermined list of requirements.

12. The method of claim 11, wherein the interested party is an employer, wherein the verified assets are objects related to employment, and wherein the predetermined list of requirements is a list of job-specific related requirements.

13. The method of claim 1, further comprising:
determining a level of verification of the asset based on the type of asset and a set of a predetermined hierarchy of levels.

14. The method of claim 13, wherein the hierarchy of levels reflects temporal levels and wherein each temporal level reflects a particular degree and time duration of applicability.

15. A method, comprising:
receiving, from a client device over a communications network, a first request for verification of an asset, wherein the first request includes the asset;
responsive to receiving the first request from the client device, determining a verifying entity associated with the asset, wherein the verifying entity has authority to verify the asset and sending a second request over the communications network to the verifying entity for verifying the asset;
receiving, from the verifying entity, a first notification that the asset has been verified by the associated verifier;
responsive to receiving the first notification that the asset has been verified, signing and adding a transaction to a distributed ledger database, wherein the signed transaction indicates that the asset has been verified, wherein the transaction includes content representing the asset and an indicator of verification by the verifying entity; and
transmitting a second notification to the client device that the asset has been verified.

16. The method of claim 15, wherein an asset is associated with an individual and is digital information representing one of: a line of a resume; a degree from a secondary education institution; a certificate of qualification for being able to draft executable code in a specific coding language; a professional reference; one or more specific courses completed at an educational institution; length of time employed at a specific place of employment; length of time in a specific position at a specific place of employment; a transcript from an educational institute; a resume; or a profile.

17. The method of claim 15, further comprising:
creating a trusted relationship with the client device by registering the client device and negotiating trust with the client device.

18. The method of claim 15, wherein the received asset is contained in a received document, the received document is a digital resume or digital profile, and further comprising:
parsing the received document to extract the asset.

19. The method of claim 15, further comprising:
determining a level of verification of the asset based on the type of asset and a set of a predetermined hierarchy of levels, wherein the hierarchy of levels reflects temporal levels, and wherein each temporal level reflects a particular degree and time duration of applicability.

20. A platform, comprising:
a receiving processor for receiving, from a client device over a communications network, a first request for verification of an asset, wherein the first request includes the asset;
an analytics processor for determining, responsive to receiving the first request from the client device, a verifying entity associated with the asset, wherein the verifying entity has authority to verify the asset;
a transmitting processor for transmitting a second request over the communications network to the verifying entity for verifying the asset;
a signing and adding processor for signing and added a first transaction to a distributed ledger database, wherein the signed first transaction includes content representing the asset, wherein the distributed ledger database is configured to be accessed by the verifying entity for verifying the asset;
wherein the signing and added processor is configured to receive, from the distributed ledger database, a first notification that the asset has been verified by the associated verifier, wherein a second transaction has been added to the distributed ledger database, the second transaction being signed by the verifying entity and including the content representing the asset and an indicator of verification by the verifying entity; and
a notification processor for transmitting a second notification to the client device that the asset has been verified.
